(19) United States
(12) Patent Application Publication
(10) Pub. No.: US 2025/0309377 A1
(43) Pub. Date: Oct. 2, 2025

(54) BATTERY SYSTEM

(71) Applicant: HONDA MOTOR CO., LTD., Tokyo (JP)

(72) Inventor: Keishi KOSAKA, Saitama (JP)

(21) Appl. No.: 19/064,631

(22) Filed: Feb. 26, 2025

(30) Foreign Application Priority Data
Mar. 30, 2024 (JP) 2024-058337

(51) Int. Cl. H01M 10/42; H01M 10/48; H01M 50/204; H01M 50/242

(52) U.S. Cl. CPC H01M 10/425; H01M 10/482; H01M 50/204; H01M 50/242

(57) ABSTRACT

A battery system according to one embodiment of the present invention includes: a battery module including a cell stack formed by stacking a plurality of battery cells, and a pair of end plates arranged at both ends of the cell stack in the stacking direction, in which a fluid cushion is arranged either between the battery cells, or between the battery cells and the end plates, or both; a pressure acquisition unit; and a battery cell control unit. The cell thickness of the battery cells increases as the state of charge increases, and decreases as the state of charge decreases. The pressure acquisition unit acquires the internal pressure of the fluid cushion. The battery cell control unit controls at least one of the state of charge and temperature of the battery cells, based on the internal pressure of the fluid cushion.

This application is based on and claims the benefit of priority from Japanese Patent Application No. 2024-058337, filed on 30 Mar. 2024, the content of which is incorporated herein by reference.

### BACKGROUND OF THE INVENTION

### Field of the Invention

The present invention relates to a battery system.

### Related Art

In recent years, research and development have been conducted on secondary batteries that contribute to energy efficiency, in order to enable more people to access affordable, reliable, sustainable, and advanced energy. Battery systems that utilize a battery module combining a plurality of secondary batteries are employed for driving vehicle motors, such as in electric vehicles and hybrid electric vehicles.

In battery systems, pressure is exerted on all-solid-state battery cells in a cell stack to improve electrical performance, including high-rate performance. For example, consideration has been given to regulating the pressure exerted on a cell stack by using a pressure pack that expands and contracts as a pressure medium (fluid) is supplied or discharged by a pump, based on the state of charge (SOC) of the cell stack (see Patent Document 1). Additionally, consideration has also been given to arranging a fluid cushion between the all-solid-state battery cells in the cell stack, and regulating the pressure of the fluid cushion using a fluid pressure adjustment mechanism, such as a pump combined with valves (see Patent Document 2).

Patent Document 1: Japanese Unexamined Patent Application, Publication No. 2008-288168

Patent Document 2: European Patent Application, Publication No. 3886202

### SUMMARY OF THE INVENTION

In battery system technology using secondary batteries, a size reduction is a recognized challenge. However, in conventional battery systems, when exerting pressure on the battery cells in a cell stack using fluid, a fluid supply device such as a pump is required, making it difficult to reduce the size of the battery system.

The present invention has been made in view of the above circumstances, and aims to provide a battery system that can be reduced in size without particularly requiring a fluid supply device, and is capable of uniformly exerting a specified pressure on the battery cells using a fluid cushion. Consequently, the present invention contributes to increased energy efficiency.

The inventors of the present invention have found that the aforementioned problems can be solved by controlling at least one of the state of charge and the temperature of the battery cells, based on the internal pressure of the fluid cushion, thereby arriving at completion of the present invention. Therefore, the present invention provides the following.

(1) A battery system that includes: a battery module including a cell stack in which a plurality of battery cells are stacked, and a pair of end plates arranged at both ends of the cell stack in a stacking direction, in which a fluid cushion is arranged either between the battery cells or between the battery cells and the end plates, or both; a pressure acquisition unit; and a battery cell control unit. The cell thickness of the battery cells increases as the state of charge increases, and decreases as the state of charge decreases. The pressure acquisition unit acquires the internal pressure of the fluid cushion. The battery cell control unit controls at least one of the state of charge and the temperature of the battery cells, based on the internal pressure of the fluid cushion.

The battery system as described in (1) regulates the internal pressure of the fluid cushion by controlling at least one of the state of charge and the temperature of the battery cells, based on the internal pressure of the fluid cushion; therefore, the system does not need use a fluid supply device. Consequently, the battery system as described in (1) can be reduced in size by eliminating the need for a fluid supply device.

(2) In the battery system as described in (1), in a case where the internal pressure of the fluid cushion is equal to or greater than a predetermined reference value of the internal pressure, the battery cell control unit executes control of decreasing at least one of the state of charge or the temperature of the battery.

The battery system as described in (2) controls at least one of the state of charge and the temperature of the battery cells to decrease; therefore, the internal pressure of the fluid cushion can be reduced without requiring a fluid supply device.

(3) In the battery system as described in (1), in a case where the internal pressure of the fluid cushion is equal to or less than a predetermined reference value, the battery cell control unit controls at least one of the state of charge and the temperature of the battery cells to increase.

The battery system as described in (3) controls at least one of the state of charge and the temperature of the battery cells to increase; therefore, the internal pressure of the fluid cushion can be raised without requiring a fluid supply device.

The present invention makes it possible to provide a battery system that can be reduced in size easily without particularly requiring a fluid supply device, and is capable of uniformly exerting a specified pressure on the battery cells using a fluid cushion.

### BRIEF DESCRIPTION OF THE DRAWINGS

FIG. 1 is a schematic diagram illustrating the configuration of a battery system according to one embodiment of the present invention;

FIG. 2 is a flowchart illustrating the operation of the battery system according to one embodiment of the present invention;

FIG. 3 is a schematic diagram illustrating a first modification of the battery system according to one embodiment of the present invention; and FIG. 4 is a schematic diagram illustrating a second modification of the battery system according to one embodiment of the present invention.

### DETAILED DESCRIPTION OF THE INVENTION

Hereinafter, embodiments of the present invention will be described with reference to the drawings. However, the embodiments described below are merely illustrative and do not limit the scope of the present invention.

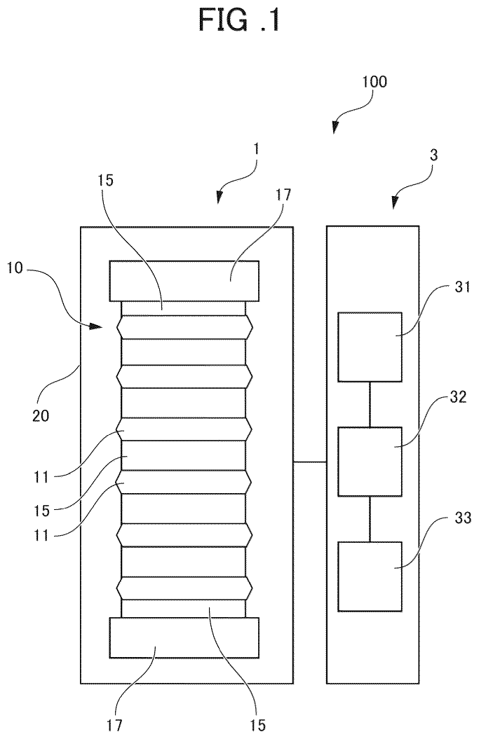

FIG. 1 is a schematic diagram illustrating the configuration of a battery system according to one embodiment of the present invention.

As illustrated in FIG. 1, a battery system 100 of the present embodiment includes a battery module 1 and a control device 3. The battery module 1 includes a cell stack 10 formed by stacking a plurality of battery cells 11, and a pair of end plates 17 arranged at both ends of the cell stack 10 in the stacking direction. Fluid cushions 15 are arranged between the battery cells 11, and between the battery cell 11 and the end plates 17. The battery module 1 is housed within a module case 20. The control device 3 controls at least one of the state of charge and the temperature of the battery cells 11, thereby regulating the internal pressure of the fluid cushions 15. The control device 3 includes a pressure acquisition unit 31, a battery cell control unit 32, and a temperature regulator 33.

Each battery cell 11 is an all-solid-state lithium metal secondary battery. The all-solid-state lithium metal secondary battery includes an electrode stack that includes a positive electrode, a negative electrode, and a solid electrolyte layer arranged between the positive electrode and the negative electrode. The all-solid-state lithium metal secondary battery utilizes lithium ions as a charge transfer medium, deposits lithium ions on the negative electrode to form a lithium metal layer during charging, and occludes the lithium ions released from the lithium metal layer in the positive electrode during discharging. Due to the increase and decrease in thickness of the negative electrode caused by the formation and depletion of the lithium metal layer, the thickness of the lithium metal secondary battery increases with the rising state of charge (SOC) during charging, and decreases with the falling state of charge during discharging.

The positive electrode includes a positive electrode current collector and a positive electrode active material layer containing a positive electrode active material. The positive electrode current collector is connected to a positive electrode tab 12. Examples of materials for the positive electrode current collector include aluminum, aluminum alloy, stainless steel, nickel, iron, and titanium. Examples of positive electrode active materials include layered active materials containing lithium, spinel-type active materials, and olivine-type active materials. Specific examples of positive electrode active materials include lithium cobalt oxide (LiCoO₂), lithium nickel oxide (LiNiO₂), LiNiₚMn_{q}CoᵣO₂ (where p+q+r=1), LiNiₚAl_{q}CoᵣO₂ (where p+q+r=1), lithium manganese oxide (LiMn₂O₄), heteroelement-substituted Li-Mn spinel such as Li₁₊ₓMn_{2-x-y}MO₄ (where x+y=2, and M is at least one element selected from Al, Mg, Co, Fe, Ni, and Zn), lithium titanate (an oxide containing Li and Ti), and lithium metal phosphate (LiMPO₄, where M is at least one element selected from Fe, Mn, Co, and Ni). The negative electrode includes a negative electrode current collector and a metal layer that promotes uniform lithium metal deposition. The negative electrode current collector is connected to a negative electrode tab 13. Examples of materials for the negative electrode current collector include nickel, copper, and stainless steel. Examples of materials that can be used for the metal layer include lithium and metals that form an alloy with lithium. Examples of metals that form alloys with lithium include Mg, Si, Au, Ag, In, Ge, Sn, Pb, Al, and Zn.

The solid electrolyte layer includes a solid electrolyte. Examples of solid electrolytes include sulfide-based electrolyte, oxide-based electrolyte, nitride-based electrolyte, and halide solid electrolyte.

The stacking direction of each layer in the battery cell 11 aligns with the stacking direction of the cell stack 10. Accordingly, changes in the thickness of the negative electrode layer in the battery cell 11 result in corresponding changes in the thickness of the battery cell 11 in the stacking direction of the cell stack 10. Consequently, as the thickness of the battery cell 11 in the stacking direction changes, the pressure exerted by the battery cell 11 on the fluid cushions 15 increases or decreases, leading to changes in the internal pressure of the fluid cushions 15.

Each fluid cushion 15 includes a housing and fluid filled within the housing. An example of the material that can be used for the housing is an aluminum laminated film. Either gas or liquid may be used for the fluid. An example of gas that can be used is nitrogen. Examples of liquids that can be used include mineral-based hydraulic oil, phosphate ester-based hydraulic oil, water, and glycol-based solvents.

The end plates 17 function to restrain the cell stack 10 in the stacking direction. The restraining force of the end plates 17 allows for regulating the surface pressure exerted by the fluid cushions 15 on the cell stack 10. The material for the end plate 17 is not particularly limited, and various materials commonly used for the end plates of battery modules can be employed.

The pressure acquisition unit 31 acquires the internal pressure of the fluid cushions 15. The method of acquiring the internal pressure is not particularly limited. As the method of acquiring the internal pressure of the fluid cushion 15, for example, the internal pressure of each fluid cushion 15 can be measured using a pressure sensor. Alternatively, the internal pressure of the fluid cushion 15 can be calculated based on Boyle-Charle's law, represented by the following Equation (1). P×V/T=constant (1) In the Equation (1), P represents the pressure of the fluid cushion, V represents the volume of the fluid cushion, and T represents the temperature of the fluid cushion.

The battery cell control unit 32 controls at least one of the state of charge and the temperature of the battery cells 11, based on the internal pressure of the fluid cushions 15. The battery cell control unit 32 controls the state of charge of the battery cells 11 by charging or discharging the battery cells 11. Additionally, the battery cell control unit 32 operates the temperature regulator 33 to regulate the temperature within the module case 20, thereby controlling the temperature of the battery cells 11.

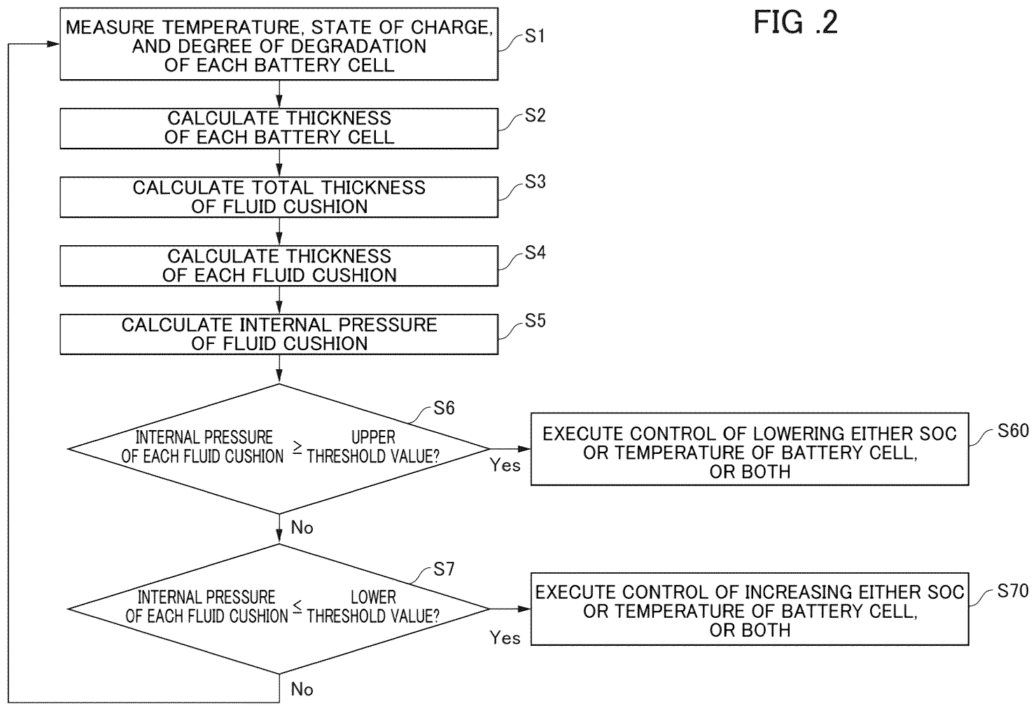

Next, the operation of the battery system 100 of the present embodiment will be described with reference to FIG. 2, taking as an example the case of using the battery system 100 for driving a motor of an electric vehicle. FIG. 2 is a flowchart illustrating the operation of the battery system according to one embodiment of the present invention.

First, as illustrated in FIG. 2, in Step S1, the temperature, the state of charge, and the degree of degradation of the battery cell 11 are measured. The temperature of the battery cell 11 can be measured using, for example, a thermometer. The state of charge of the battery cell 11 can be obtained by measuring the potential of the battery cell 11, and substituting the measured potential into a predetermined relational expression between degree of degradation, potential, and state of charge. The degree of degradation of the battery cell 11 represents the extent of reduction in the charge-discharge capacity of the battery cell 11. The degree of degradation can be determined by measuring the charge-discharge capacity of each battery cell 11 during each charge-discharge cycle. Additionally, the degree of degradation can be determined based on the degree of increase in internal resistance of each battery cell 11 over successive charge-discharge cycles.

Next, in Step S2, the thickness of each battery cell 11 is calculated. The thickness of each battery cell 11 can be calculated, for example, by substituting the data obtained in Step S1 into a predetermined relational expression that associates thickness of the battery cell 11, temperature of the battery cell 11, state of charge, and degree of degradation.

Subsequently, in Step S3, the total thickness of the fluid cushions 15 is calculated. The total thickness of the fluid cushions 15 can be calculated, for example, by subtracting the total thickness of all of the battery cells 11 from the overall thickness of the cell stack 10.

In Step S4, the thickness of each fluid cushion 15 is calculated. The thickness of each fluid cushion 15 can be calculated by, for example, dividing the total thickness of the fluid cushions 15 obtained in Step S3 by the number of fluid cushions 15 within the cell stack 10.

Next, in Step S5, the internal pressure of each fluid cushion 15 is calculated. The internal pressure of each fluid cushion 15 can be calculated, for example, by substituting the volume V of each fluid cushion 15, as obtained from the thickness of each fluid cushion 15 calculated in Step S4, and the temperature T of each fluid cushion 15, as measured by a thermometer, into the previously mentioned Equation (1).

Through Steps S1 to S5, the internal pressure of each fluid cushion 15 is obtained. Steps S1 to S5 are carried out by the pressure acquisition unit 31.

In Step S6, determination is made on whether the internal pressure of the fluid cushion 15 as obtained in Step S5 is equal to or greater than an upper threshold value. If the internal pressure of the fluid cushion 15 is equal to or greater than the upper threshold value (Yes), the processing proceeds to Step S60. If the internal pressure of the fluid cushion 15 is equal to or less than the upper threshold value (No), the processing proceeds to Step S7. When the internal pressure of the fluid cushion 15 is excessively high, there is a risk of exerting excessive pressure by the fluid cushion 15 on the battery cells 11 and the end plates 17. Therefore, an upper threshold value for the internal pressure of the fluid cushion 15 is set. The upper threshold value for the internal pressure of the fluid cushion 15 may be set based on factors such as the operational state of the electric vehicle (e.g., driving, charging, parking) and the state of charge of each battery cell 11.

In Step S60, the internal pressure of the fluid cushion 15 is regulated to be equal to or less than the upper threshold value by lowering either the SOC, or the cell temperature, or both. The SOC represents the state of charge (charging rate) of each battery cell 11. In a case where the internal pressure of the fluid cushion 15 remains above the upper threshold value even after performing an operation to reduce the SOC, an operation may be performed to lower the cell temperature. Generally, as the SOC of the battery cell 11 is reduced through discharge, the cell thickness decreases, leading to a reduction in internal pressure of the battery cell 11. Lowering the temperature of the battery cell 11 results in a drop in the temperature of the fluid cushion 15, consequently reducing the internal pressure of the fluid cushion 15, decreasing the pressure exerted on the battery cell 11, and leading to a reduction in internal pressure of the battery cell 11.

While the electric vehicle is in running, the SOC can be reduced by the following operations. The chiller is activated to discharge the battery cell 11. The chiller is a water circulation cooling device. The electric coolant heater (ECH) is activated to discharge the battery cell 11. The ECH is an electric coolant heater. The equalization circuit of the cell monitoring unit (CMU) is activated to regulate the SOC of each battery cell 11. The battery cell monitoring unit (CMU) is a controller that controls the charge and discharge of the battery cells 11. For example, the CMU can be used to control the charging of the battery cells 11 by regenerative energy.

While the electric vehicle is running, the cell temperature can be reduced by activating the chiller to lower the temperature of the cooling water.

While the electric vehicle is charging, the SOC can be reduced by the following operations. The chiller is activated to discharge the battery cell 11. The ECH is activated to discharge the battery cell 11. The equalization circuit of the CMU is activated to regulate the SOC of each battery cell 11. The charging current is regulated.

While the electric vehicle is charging, the cell temperature can be lowered by activating the chiller to lower the temperature of the cooling water.

While the electric vehicle is parked (not charging), the SOC can be reduced by the following operations. The chiller is activated to discharge the battery cell 11. The ECH is activated to discharge the battery cell 11. The equalization circuit of the CMU is activated to regulate the SOC of each battery cell 11.

When the electric vehicle is parked (not charging), the cell temperature can be reduced by activating the chiller to lower the temperature of the cooling water.

In Step S7, determination is made on whether the internal pressure of the fluid cushion 15 is equal to or less than the lower threshold value. If the internal pressure of the fluid cushion 15 is equal to or less than the lower threshold value (Yes), the processing proceeds to Step S70. If the internal pressure of the fluid cushion 15 is above the lower threshold value (No), the processing returns to Step S1. If the internal pressure of the fluid cushion 15 decreases excessively, the pressure exerted by the fluid cushion 15 on the battery cell 11 may become excessively low, leading to an increase in contact resistance among the positive electrode layer, the solid electrolyte layer, and the negative electrode layer of the battery cell 11, potentially degrading the performance of the battery cell 11. Therefore, the lower threshold value is set for the internal pressure of the fluid cushion 15. The lower threshold value for the internal pressure of the fluid cushion 15 may be set based on factors such as the operational state of the electric vehicle (e.g., driving, charging, parking) and the state of charge of each battery cell 11.

In Step S70, the internal pressure of the fluid cushion 15 is regulated above the lower threshold value by increasing either the SOC, or the cell temperature, or both. In a case where the internal pressure of the fluid cushion 15 remains to be equal to or less than the lower threshold value even after performing an operation to increase the SOC, an operation to raise the cell temperature may be performed. Generally, as the SOC of the battery cell 11 increases, the cell thickness also increases, resulting in a rise in internal pressure of the battery cell 11. Generally, as the temperature of the battery cell 11 rises, the temperature of the fluid cushion 15 also increases, leading to a higher internal pressure of the fluid cushion 15, which increases the pressure exerted on the battery cell 11, thereby raising the internal pressure of the battery cell 11.

While the electric vehicle is running, the SOC can be increased by the following operations. The chiller is stopped. The ECH is stopped. The battery cell 11 is charged using regenerative energy.

While the electric vehicle is running, the cell temperature can be raised by activating the ECH to increase the temperature of the cooling water. Preferably, the ECH is controlled in balance with the degree of increase in cell temperature and the degree of reduction in SOC due to increased energy consumption required by the electric vehicle.

While the electric vehicle is charging, the SOC can be increased by the following operations. The chiller is stopped. The ECH is stopped. The charging current is increased.

When the electric vehicle is charging, the cell temperature can be raised by activating the ECH to increase the temperature of the cooling water.

While the electric vehicle is parked (not charging), the SOC can be increased by the following operations. The chiller is stopped. The ECH is stopped.

While the electric vehicle is parked (not charging), the cell temperature can be raised by activating the ECH to increase the temperature of the cooling water.

Steps S6, S60, S7, and S70 are executed by the battery cell control unit 32 and the temperature regulator 33.

The operations in Steps S1 through S7 may be repeated either continuously or intermittently.

The upper threshold value and the lower threshold value for the internal pressure of the fluid cushion 15 may be set based on the state of the electric vehicle, such as running or charging. The upper threshold value and the lower threshold value for the internal pressure of the fluid cushion 15 may also be set based on the state of charge of each battery cell 11.

The battery system 100 of the present embodiment, with the above configuration, regulates the internal pressure of the fluid cushion 15 by controlling at least one of the state of charge and the temperature of the battery cell 11, based on the internal pressure of the fluid cushion 15, thereby obviating the need for a fluid supply device. Consequently, the battery system 100 of the present embodiment allows for a size reduction by eliminating the fluid supply device.

According to the battery system 100 of the present embodiment, in a case where the internal pressure of the fluid cushion 15 is equal to or greater than the preset reference value (upper threshold value), at least one of the state of charge and the temperature of the battery cell 11 is controlled to decrease, thereby allowing for reducing the internal pressure of the fluid cushion 15 without the need for a fluid supply device. According to the battery system 100 of the present embodiment, in a case where the internal pressure of the fluid cushion 15 is equal or less than the preset reference value (lower threshold value), at least one of the state of charge and the temperature of the battery cell 11 is controlled to increase, thereby raising the internal pressure of the fluid cushion 15 without the need for a fluid supply device.

While an embodiment of the present invention has been described above, the present invention is not limited to the embodiment. For example, in the present embodiment, the fluid cushions 15 are arranged between the battery cells 11 and between the battery cells 11 and the end plates 17; however, the arranged positions of the fluid cushions 15 are not limited to this.

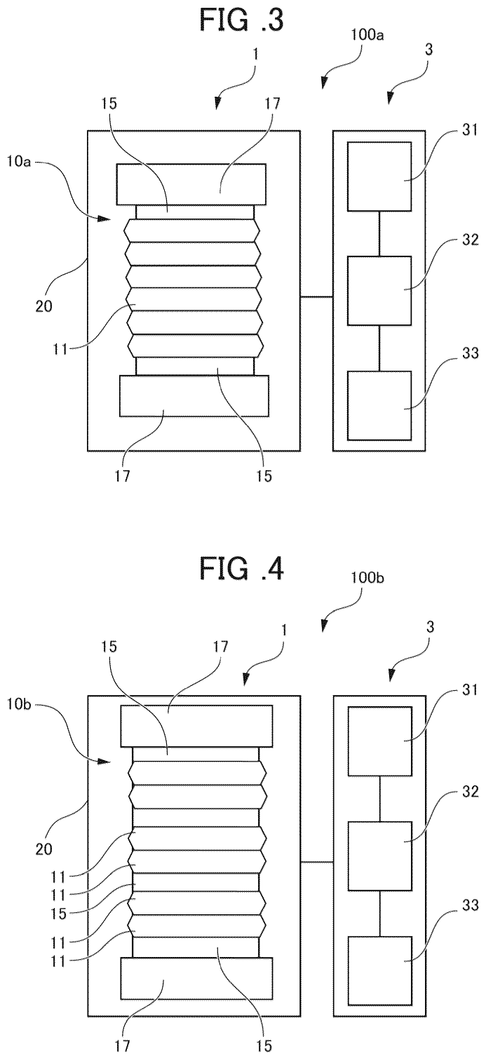

FIG. 3 is a schematic diagram illustrating a first modification of the battery system according to one embodiment of the present invention. In the battery system 100a of the first modification, the fluid cushions 15 are arranged between the battery cells 11 and the end plates 17, but not between the battery cells 11 of the cell stack 10a. The other configurations are the same as those of the battery system 100 described above, and thus the same reference numbers are assigned to the same components, and descriptions thereof are omitted.

According to the battery system 100a of the first modification, the fluid cushions 15 are arranged between the battery cells 11 and the end plates 17, and the thickness of each battery cell 11 in the cell stack 10a can be regulated; therefore, even when the thickness of the battery cells 11 changes during charging and discharging, misalignment of the battery cells 11 can be reduced, similarly to the battery system 100 described above. Furthermore, no fluid cushions 15 are arranged between the battery cells 11, thereby allowing for a reduction in the size of the cell stack 10a.

FIG. 4 is a schematic diagram illustrating a second modification of the battery system according to one embodiment of the present invention. In the battery system 100b of the second modification, the battery cells 11 are grouped in pairs, with a fluid cushion 15 arranged between one pair of battery cells 11 and another pair of battery cells 11. The other configurations are the same as those of the battery system 100; therefore, the same reference numbers are assigned to the same components, and descriptions thereof are omitted.

According to the battery system 100b of the second modification, the fluid cushions 15 are arranged between the battery cells 11 and the end plates 17 and between each pair of battery cells 11, and the thickness of each battery cell 11 in the cell stack 10b can be regulated; therefore, even when the thickness of battery cells 11 changes during charging and discharging, misalignment of the battery cells 11 can be reduced, similarly to the battery system 100 described above. Furthermore, no fluid cushions 15 are arranged between the battery cells 11, thereby allowing for a reduction in the size of the cell stack 10a.

In the battery system 100 of the present embodiment, an all-solid-state lithium metal secondary battery is used as the battery cell 11; however, the battery cell 11 is not limited to this type. For example, a non-aqueous solvent lithium metal secondary battery that uses a non-aqueous solvent as the electrolyte may also be used. The battery cell 11 used in the battery system 100 of the present embodiment may be any cell, as long as the thickness increases with an increase in the state of charge, and decreases with a decrease in the state of charge. For example, when the cell thickness at discharge is set to 100, the thickness of the battery cell 11 may fall within a range of 101 to 150.

In the present embodiment, the battery system 100 has been described for use in driving an electric vehicle; however, the use applications of the battery system 100 are not limited to this. The battery system 100 of the present embodiment can also be used as a power source for motors in vehicles other than electric vehicles, such as hybrid electric vehicles (including plug-in hybrid electric vehicles). Additionally, the battery system 100 of the present embodiment can be used as a power source for mobile devices and as a power storage system for power generation facilities.

### EXPLANATION OF REFERENCE NUMERALS

1: battery system
3: control unit
10: cell stack
11: battery cell
15: fluid cushion
17: end plate
20: module case
31: pressure acquisition unit
32: battery cell control unit
33: temperature regulator
100, 100a, 100b: battery system

What is claimed is:

1. A battery system, comprising:
a battery module including a cell stack in which a plurality of battery cells are stacked, and a pair of end plates arranged at both ends of the cell stack in a stacking direction, in which a fluid cushion is arranged either between the battery cells, or between the battery cells and the end plates, or both;
a pressure acquirer; and
a battery cell controller, wherein
a cell thickness of the battery cells increases as a state of charge increases, and decreases as the state of charge decreases,
the pressure acquirer acquires an internal pressure of the fluid cushion, and
the battery cell controller controls at least one of the state of charge and temperature of the battery cells, based on the internal pressure of the fluid cushion.

2. The battery system according to claim 1, wherein, in a case where the internal pressure of the fluid cushion is equal or greater than a predetermined reference value of the internal pressure, the battery cell controller executes control of decreasing at least one of the state of charge or the temperature of the battery.

3. The battery system according to claim 1, wherein, in a case where the internal pressure of the fluid cushion is equal to or less than a predetermined reference value, the battery cell controller controls at least one of the state of charge and temperature of the battery cells to increase.
